(19) United States
(12) Patent Application Publication
(10) Pub. No.: US 2021/0001684 A1
(43) Pub. Date: Jan. 7, 2021

(54) AIR CONDITIONER WITH PIPE SUPPORT

(71) Applicant: DENSO CORPORATION, Kariya-city (JP)

(72) Inventor: Masahiro TOMINAGA, Kariya-city (JP)

(21) Appl. No.: 17/025,988

(22) Filed: Sep. 18, 2020

Related U.S. Application Data
(63) Continuation of application No. PCT/JP2019/001949, filed on Jan. 23, 2019.

(30) Foreign Application Priority Data
Mar. 22, 2018 (JP) 2018-055000

(51) Int. Cl. B60H 1/00; B60H 1/04

(52) U.S. Cl. CPC B60H 1/00521; B60H 1/004; B60H 1/04; B60H 1/00328

(57) ABSTRACT

According to the disclosed air conditioner with a pipe support, both a seat member and a holder member are provided by a base portion and a cover portion. The seat member is provided by the base end portion and the cover end portion. The holder member is provided by the base depression portion and the cover depression portion. The holder member is positioned behind the seat member and supports the end pipes. The base portion and the cover portion are connected by a connecting mechanism. Behind the seat member, the holder member supports the end pipes, so that the end pipes are held stably.

### CROSS REFERENCE TO RELATED APPLICATIONS

The present application is a continuation application of International Patent Application No. PCT/JP2019/001949 filed on Jan. 23, 2019, which designated the U.S. and claims the benefit of priority from Japanese Patent Application No. 2018-055000 filed in Japan filed on Mar. 22, 2018, the entire disclosure of the above application is incorporated herein by reference.

### TECHNICAL FIELD

This disclosure relates to an air conditioner with a pipe support.

### BACKGROUND

An air conditioner needs a pope support structure. The pipe support enables hold at least one pipe member which penetrates a wall.

### SUMMARY

In the known viewpoint, or in other viewpoint that has not been described, further improvement is demanded for an air conditioner with a pipe support.

An air conditioner with a pipe support disclosed herein comprises: a case accommodating a heat exchanger for exchanging heat between air and a heat medium; at least one end pipe extends toward the heat exchanger from a partition wall portion which partitions a target room in which the case is arranged and a machine room and fluidly communicated with the heat exchanger; a seat positioned to face the partition wall portion and to which the end pipe is positioned; a seal mounted on the seat member and positioned between the facing portion and the partition wall portion; and a holder which supports the end pipe, wherein the seat and the holder are provided by a base portion formed of a resin material integrally with the case, a cover portion separately formed with the case, and a connecting mechanism which connects the base portion and the cover portion, and wherein the base portion extends from the case toward the partition wall portion and has an base end portion providing a part of the seat and a base depression portion which is positioned behind the base end portion and supports the end pipe as the holder, and wherein the cover portion is formed to be connected with the base portion and has a cover end portion providing a remaining part of the seat and a cover depression portion which is positioned behind the cover end portion and supports the end pipe as the holder.

According to the disclosed air conditioner with a pipe support, both the seat member and the holder member may be provided by the base portion and the cover portion. Moreover, the base depression portion and the cover depression portion provide the holder member and are positioned behind the base end portion and the cover end portion both providing the seat member. Therefore, it is possible to support the end pipe(s) by the holder behind the seat member. As a result, a stable holding of the end pipe is provided.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

### BRIEF DESCRIPTION OF DRAWINGS

The disclosure is further described with reference to the accompanying drawings in which:

FIG. 1 is a perspective view of a vehicle showing an air conditioner according to a first embodiment;

FIG. 2 is a schematic rear view of the air conditioner;

FIG. 3 is an exploded perspective view showing a pipe support of an air conditioner;

FIG. 4 is a rear view showing a base portion of the pipe support;

FIG. 5 is a side view showing the base portion of the pipe support;

FIG. 6 is a side view showing a cover portion of the pipe support;

FIG. 7 is a front view showing the cover portion of the pipe support;

FIG. 8 is a bottom view showing the cover portion of the pipe support;

FIG. 9 is a cross-sectional view of the cover portion; and

FIG. 10 is an enlarged end view showing an end surface of the pipe support.

### DETAILED DESCRIPTION

Hereinafter, a plurality of embodiments will be described with reference to the drawings. In some embodiments, parts which are functionally and/or structurally corresponding and/or associated are given the same reference numerals, or reference numerals with different hundreds digit or higher digits. For corresponding parts and/or associated parts, additional explanations can be made to the description of other embodiments.

JPH11-263118A discloses an air conditioner with a pipe support member including a pipe cover for fixing a heater pipe. In this technique, the pipe cover provides a bracket portion for supporting the heater pipe. JPH11-263118A is incorporated herein by reference as a part of the disclosure. In JPH11-263118A, the separate pipe cover is attached to a case of an air conditioner. The pipe cover provides a bracket portion. Further, the pipe cover supports the grommet. In this case, a fixing of the heater pipe is not stable due to deformations of the pipe cover and the bracket. In the aforementioned viewpoint, or in other viewpoint that has not been described, further improvement is demanded for an air conditioner with a pipe support. It is an object of this disclosure to provide an air conditioner with a pipe support which stably holds an end pipe or end pipes. Another object to be disclosed is to provide an air conditioner with a pipe support which has a configuration that is easy to assemble and stably holds the end pipe.

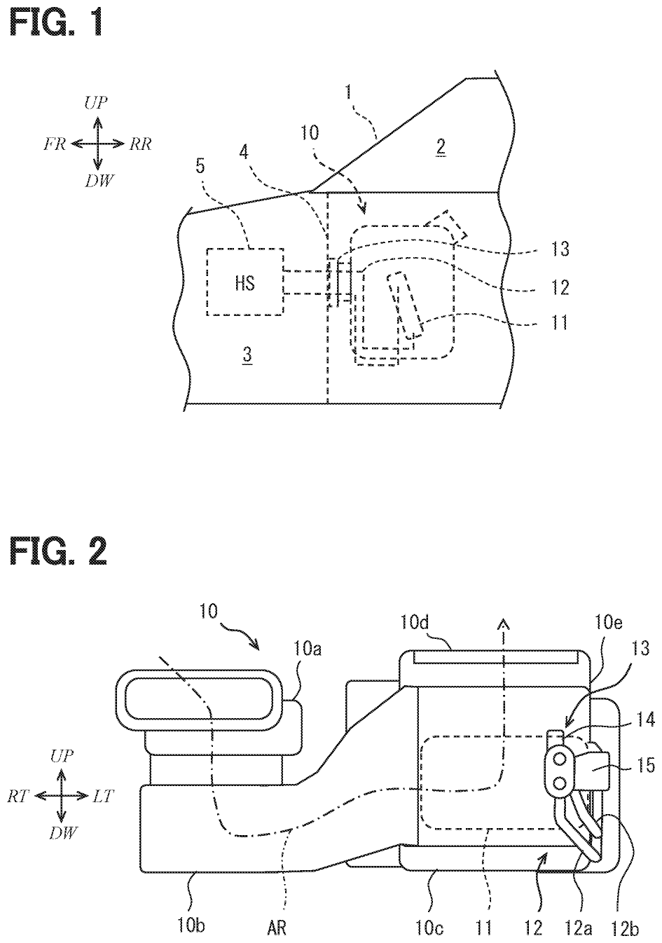

In FIG. 1, an air conditioner 10 can be used for various purposes. One application is an air-conditioning device for vehicle, including a car. Here, the term vehicle should be interpreted in a broad sense, and includes moving objects such as cars, ships, and aircrafts, and fixed objects such as amusement equipment and simulation equipment. Another application is as an air conditioner for stationary facilities such as houses and businesses. In the drawing, an upward direction UP, a downward direction DW, a left direction LT, a right direction RT, a front direction FR, and a rear direction RR of the vehicle are illustrated. The upward direction UP and the downward direction DW indicate the gravity direction.

The vehicle 1 has a temperature-controlled target room 2 for accommodating passengers or cargo. The vehicle 1 has a machine room 3 which houses a power source such as an engine or a motor. The vehicle 1 has a partition wall portion 4 arranged between the target room 2 and the machine room 3. The partition wall portion 4 is provided by a steel plate or a soundproof material which constitutes the vehicle 1. The vehicle 1 has a heat source 5 (HS) arranged in the machine room 3. The heat source 5 provides a heat medium for the air conditioner 10. The heat source 5 can be provided by, for example, an internal combustion engine (engine), an electric motor (motor), an inverter circuit, a battery, or the like. The heat medium is often a cooling liquid. The heat medium may be provided by, for example, water or antifreeze.

The vehicle 1 has an air conditioner 10. The air conditioner 10 is mounted, for example, in front of a front seat of the vehicle. The air conditioner 10 may be mounted on various positions such as a rear part and a ceiling part of the vehicle. The air conditioner 10 has a heat exchanger 11 for adjusting a temperature of air. The heat exchanger 11 is a heating heat exchanger. The heat exchanger 11 adjusts the temperature of air by exchanging heat between air and the heat medium. A heat medium passage 12 for flowing the heat medium is arranged between the heat source 5 and the heat exchanger 11. The heat medium passage 12 is a round-trip flow path pipes arranged between the heat source 5 and the heat exchanger 11. The heat medium passage 12 extends between the target room 2 and the machine room 3 through the partition wall portion 4. Further, the air conditioner 10 includes a pipe support mechanism 13. The air conditioner 10 is an air conditioner with a pipe support. The pipe support mechanism 13 supports the heat medium passage 12. The pipe support mechanism 13 is provided by a member which positions open ends of the heat medium passages 12 at prescribed positions of the partition wall portion 4.

FIG. 2 is a rear view showing the air conditioner 10. The air conditioner 10 has an inside/outside air unit 10a, a blower unit 10b, and an air conditioning unit 10c, The inside/outside air unit 10a, the blower unit 10b, and the air conditioning unit 10c each have a partial case made of resin. These partial cases are connected to each other. These partial cases forms a passage through which air for air conditioning flows. The air conditioning unit 10c has a plurality of selectable outlets 10d. A case 10e of the air conditioning unit 10c accommodates functional components such as one or more heat exchangers and one or more flow control doors. The case 10e is arranged in the target room 2.

For example, the air conditioning unit 10c has a heating heat exchanger 11 which heats air. The heat exchanger 11 is provided by a radiator which radiates a waste heat of the vehicle 1. The heat exchanger 11 may be provided by a condenser of a vapor compression refrigeration cycle. The heat exchanger 11 may be provided by a Joule heat type radiator or various heat pump cycles such as an adsorption type refrigeration cycle, a magneto-thermal effect type refrigeration cycle, a thermoelectric effect type refrigeration cycle, and the like. The air conditioner 10 may include a cooling heat exchanger. The cooling heat exchanger may be provided by an evaporator of a vapor compression refrigeration cycle. The cooling heat exchanger may be provided by various refrigeration cycles such as an adsorption refrigeration cycle, a magneto-thermal effect refrigeration cycle, and a thermoelectric effect refrigeration cycle.

A typical flow of the air AR enters from the inside/outside air unit 10a, passes through the blower unit 10b, and further passes through the air conditioning unit 10c, The air AR passes through the heat exchanger 11 in the air conditioning unit 10c and is temperature-controlled. The temperature-controlled air AR is blown out from one or a plurality of air outlets 10d. This provides air conditioning.

The pipe support mechanism 13 supports two pipes 12a and 12b. The pipes 12a and 12b provide a forward pipe and a return pipe. The pipes 12a and 12b are also called heater pipes. The pipe support mechanism 13 includes a base portion 14 integrally formed with the case 10e of the air conditioner 10. The case 10e and the base portion 14 are integrally formed of a continuous resin material. The pipe support mechanism 13 includes a cover portion 15 which is separately formed of the case 10e. The cover portion 15 is formed to be connected with the base portion 14. The cover portion 15 is made of resin. The cover portion 15 is attached to the base portion 14 and the case 10e. A basic shape of the pipe support mechanism 13 is provided by attaching the cover portion 15 on the base portion 14 and the case 10e.

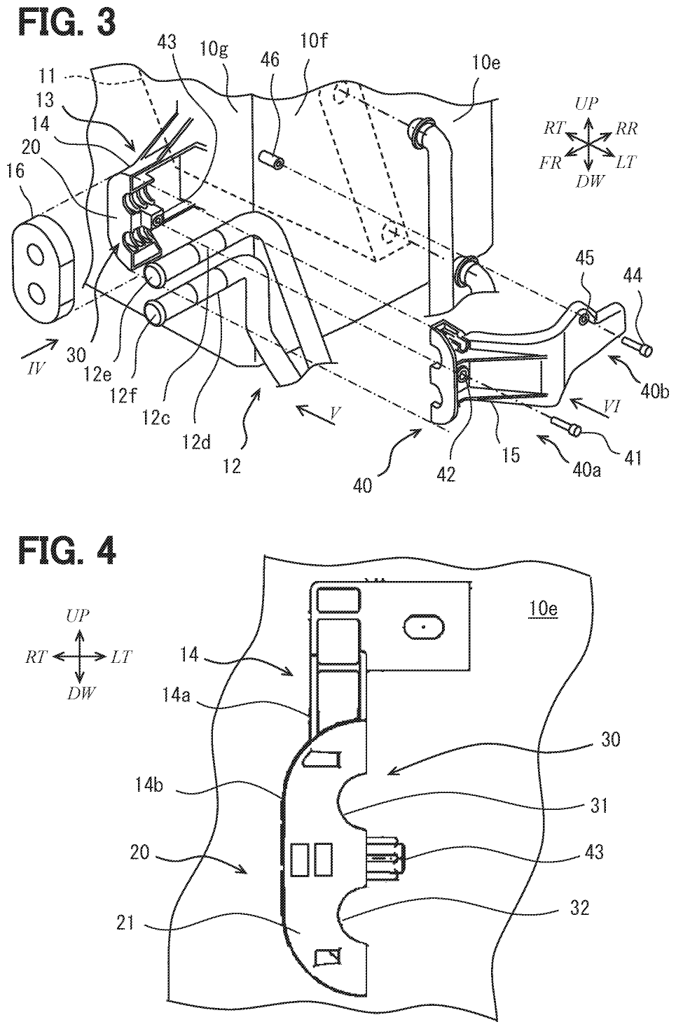

FIG. 3 is an exploded perspective view showing a disassembled state of the pipe support mechanism 13 in the air conditioner 10. The alternate long and short dash line indicates the assembling direction of the plurality of components. The pipe support mechanism 13 is arranged at a corner of the air conditioner 10. The pipe support mechanism 13 projects from the case 10e toward the machine room 3. The air conditioner 10 has a back surface 10g facing the machine room 3. The air conditioner 10 has a side surface 10f facing the side of the vehicle 1. In this embodiment, the side surface 10f is directed in the left direction LT. The air conditioner 10 can be changed to the left or right so as to comply with road regulations of an area where the vehicle 1 is used. Therefore, the direction in which the side surface 10f is directed is not limited to the illustrated embodiment.

The air conditioner 10 has a heat exchanger 11 shown by a broken line. Two pipes 12a and 12b are arranged between the heat exchanger 11 and the heat source 5. The pipes 12a and 12b have two end pipes 12c and 12d. The end pipes 12c and 12d are pipes made of metal. The end pipes 12c and 12d extend straight from the two openings 12e and 12f. The two end pipes 12c and 12d extend so as to penetrate the partition wall portion 4. The two end pipes 12c and 12d extend from the target room 2 toward the machine room 3. Therefore, at least one end pipe 12c or 12d extends toward the heat exchanger 11 from the partition wall 4. The partition wall 4 partitions the target room 2 in which the case 10e is arranged and the machine room 3. At least one end pipe 12c or 12d is fluidly communicated with the heat exchanger 11. The two end pipes 12c and 12d are parallel to each other. The two end pipes 12c and 12d are arranged in an up and down relations.

The pipe support mechanism 13 has a seal member 16. The seal member 16 is attached to the pipe support mechanism 13. The seal member 16 is arranged between the partition wall portion 4 and the pipe support mechanism 13. The seal member 16 functions as a water and air sealing member which suppresses a gap between the partition wall portion 4 and the pipe support mechanism 13. The seal member 16 also functions as a soundproof member which suppresses noise from the machine room 3 to the target room 2. The seal member 16 may be provided by urethane, rubber, or elastomer. The seal member 16 may be provided by a rubber grommet. The seal member 16 may be called by various names such as packing, grommet, and cushion material.

The pipe support mechanism 13 has a seat member 20 for holding the seal member 16. The seal member 16 is positioned between the seat member 20 and the partition wall portion 4. The seat member 20 is provided by both the base portion 14 and the cover portion 15. The seat member 20 has a long circular shape when viewed from the machine room 3. The seat member 20 provides two through holes arranged on a longitudinal axis of the long circular shape. The two end pipes 12c and 12d are positioned in each of these through holes. The seat member 20 has a shape adapted to the seal member 16. The seat member 20 may be provided by plates. The seal member 16 is fixed on the seat member 20. The seal member 16 may be mounted on the seat member 20 by a method such as engagement, adhesion, or sticking with an adhesive tape.

The base portion 14 provides a part of the seat member 20. The base portion 14 is integrally formed with the case 10e by a resin material. The base portion 14 extends from the case 10e toward the partition wall portion 4. The base portion 14 has a block which provides a part of the seat member 20. The base portion 14 is a member provided by combining a plurality of plate-shaped portions. The outer shape of the block is also formed by a plurality of plate-shaped portions. A shape of the block corresponds to almost a half pillar.

The cover portion 15 has a block which provides the rest of the seat member 20. The cover portion 15 is a separate body from the case 10e. The cover portion 15 is connected to the base portion 14. The cover portion 15 provides a half of the seat member 20. The cover portion 15 is a member provided by combining a plurality of plate-shaped portions.

The pipe support mechanism 13 has a holder mechanism 30 which holds the pipes 12a and 12b. The holder mechanism 30 may be referred to as a holder. The holder mechanism 30 tightens the pipes 12a and 12b in a radial direction. The holder mechanism 30 is provided by a plurality of half-circular cavities formed in the base portion 14 and a plurality of half-circular cavities formed in the cover portion 15. By combining the base portion 14 and the cover portion 15 in a regular relationship, the plurality of half-circular cavities and the plurality of half-circular cavities form two openings for accommodating the tubes 12a and 12b. The two end pipes 12c and 12d are arranged and fixed in these two openings, respectively.

The holder mechanism 30 is provided adjacent to the seat member 20. The holder mechanism 30 is provided between the seat member 20 and the back surface 10g. In other words, the holder mechanism 30 is positioned immediately behind and directly behind the seat member 20. The seat member 20 and the holder member 30 are arranged adjacent to each other along an extending direction of the end pipes 12c and 12d. Therefore, a displacement of the end pipes 12c and 12d is suppressed. The end pipes 12c and 12d may be reliably positioned toward the partition wall portion 4.

The cover portion 15 is fixed to the base portion 14 and the case 10e from the side of the air conditioner 10. The cover portion 15 covers a portion including the end pipes 12c and 12d. The cover portion 15 supports and fixes the heat medium passage 12.

The pipe support mechanism 13 has a connecting mechanism 40 for fixing the cover portion 15 to the base portion 14 and the case 10e. The connecting mechanism 40 fixes the cover unit 15 from a side of the air conditioner 10. The connecting mechanism 40 includes tightening mechanisms 40a and 40b by screws and a locking mechanism 50. The locking mechanism 50 meshes two members. In addition, the locking mechanism 50 is a mechanism which connects the two members by engaging a resin made claw and a resin made hook by utilizing an elasticity of the resin. The locking mechanism 50 connects the base portion 14 and the cover portion 15 with respect to all directions. The locking member 50 connects the base portion 14 and the cover portion 15 on both sides of the two end pipes 12c and 12d. In this embodiment, two pairs of claws and hooks are arranged on both sides of the end pipes 12c and 12d. The first pair of claws and hooks is arranged above the two end pipes 12c and 12d. The second pair of claws and hooks is arranged below the two end pipes 12c and 12d.

The tightening mechanism 40a is also called a first tightening mechanism. The tightening mechanism 40a has a screw 41, a through hole 42 formed in the cover portion 15, and a female screw hole 43 formed in the base portion 14. The tightening mechanism 40a firmly connects the base portion 14 and the cover portion 15 within the holder mechanism 30. The tightening mechanism 40a is positioned between the two end pipes 12c and 12d. This allows the holder mechanism 30 to securely hold and fix the end pipes 12c and 12d.

The tightening mechanism 40b is also called a second tightening mechanism. The tightening mechanism 40b has a screw 44, a through hole 45 formed in the cover portion 15, and a female screw hole 46 formed in the side surface 10f. The female screw hole 46 may have a preformed female screw. Further, in a case that the screw 41 and/or the screw 44 is a tapping screw, the female screw hole 46 may be a hole without a screw. The tightening mechanism 40a directly fixes the cover portion 15 to the case 10e (side surface 10f) at a position apart from the base portion 14.

FIG. 4 shows the base portion 14 and is a rear view in a direction of an arrow IV in FIG. 3. The base portion 14 projects from the back surface 10g. The base portion 14 has a base stay 14a and a base block 14b. The base stay 14a extends from the back surface 10g. The base stay 14a extends from the case 10e toward the partition wall portion 4. The base stay 14a is formed of a plurality of plate-shaped portions. The base block 14b is arranged at a distal end of the base stay 14a. The base block 14b has a base end portion 21 and base depression portion 31 and 32. The base block 14b has a basic shape obtained by dividing a cylindrical block body having a long circular cross section into two along a longitudinal axis. The base block 14b has a base end portion 21 as the base member 20 on the end surface. The base end portion 21 faces the partition wall portion 4 and provides a flat surface portion which spreads in parallel with the partition wall portion 4. The base end portion 21 provides a portion of the seat member 20. The base block 14b provides the holder mechanism 30. The base portion 14 has a plurality of half-circular cavities for the holder mechanism 30 on a half-divided surface of the base block 14b. The base block 14b has a half-circular cavity on the major axis which provides the holder mechanism 30. The base block 14b has base depressions 31 and 32 having half-circular inner surfaces. The base block 14b has a female screw hole 43. The base stay 14a extends parallel to the pipes 12a and 12b between the base block 14b and the back surface 10g.

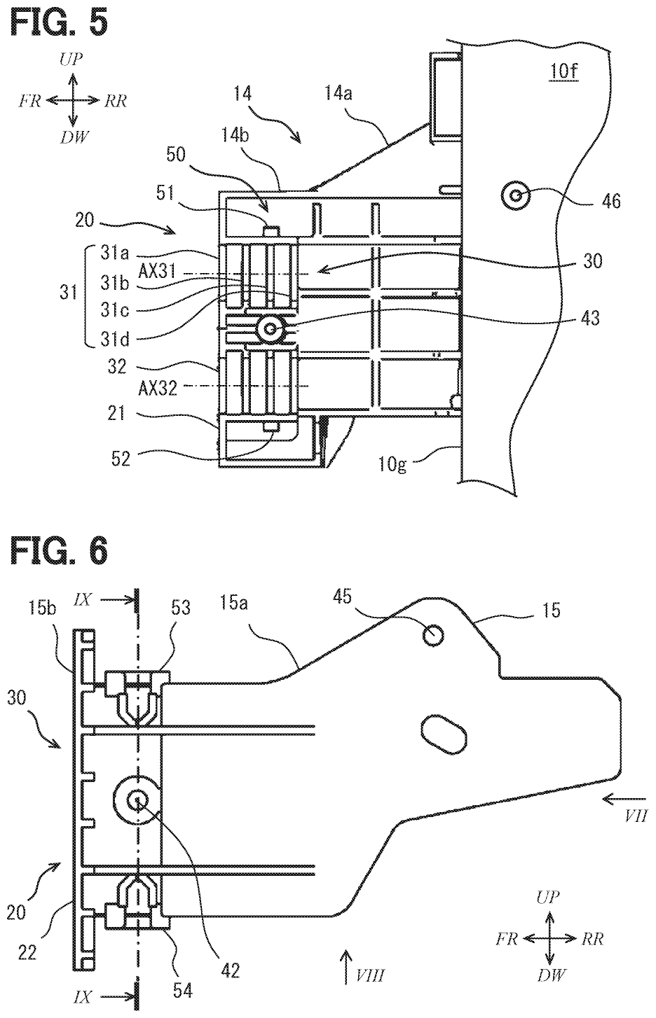

FIG. 5 shows the base portion 14 and is a rear view in a direction of an arrow V in FIG. 3. As illustrated, the base stay 14a extends from the back surface 10g. The base block 14b has the base depression portions 31 and 32 which provide the holder mechanism 30 on the surface forming the longitudinal axis. The base depression portions 31 and 32 are positioned behind the base end portion 21 and support the end pipes 12c and 12d as the holder mechanism 30. One half-circular depression is formed by a plurality of half-circular depression plates. For example, one base depression portion 31 is formed by a plurality of base depression plates 31a, 31b, 31c, and 31d. The plurality of base depression plates 31a, 31b, 31c, and 31d are arranged along a central axis AX31 of the base depression portion 31. The base depression portion 32 also has a similar shape. The base depression portion 32 has a central axis AX32. The central axes AX31 and AX32 are also the central axes of the end pipes 12c and 12d arranged therein. The central axes AX31 and AX32 extend from the air conditioner 10 toward the partition wall portion 4. The central axes AX31 and AX32 extend so as to penetrate the partition wall portion 4. The central axes AX31 and AX32 are perpendicular to the partition wall portion 4.

The female screw hole 43 is positioned between the two base depression portions 31 and 32. Tightening force of the tightening mechanism 40a is applied to the female screw hole 43. Therefore, the tightening force of the tightening mechanism 40a acts to securely tighten the end pipes 12c and 12d in the holder mechanism 30. The base block 14b has craws 51 and 52 for the locking mechanism 50. The claws 51 and 52 project from the base block 14b. The female screw hole 46 is located away from the female screw hole 43. As a result, a rotation of the cover portion 15 is prevented.

FIG. 6 shows the cover portion 15 and is a side view in a direction of an arrow VI in FIG. 3. The cover portion 15 is also a protector plate that protects a side surface of the air conditioner 10 by covering it. The cover portion 15 has a cover stay 15a extending along the base portion 14 from above the side surface 10f. The cover portion 15 has a cover block 15b. The cover block 15b is arranged at a distal end of the cover stay 15a. The cover block 15b has a cover end portion 22 and cover depression portions 33 and 34. The cover block 15b is thinner than the base block 14b. The cover block 15b has a cover end portion 22 as the seat member 20 on the end surface. The base end portion 22 faces the partition wall portion 4 and provides a flat surface portion which spreads in parallel with the partition wall portion 4. The cover end portion 22 provides the rest of the seat member 20. The cover block 15b provides the holder mechanism 30. Further, the cover block 15b has hooks 53 and 54 for the locking mechanism 50. The hooks 53 and 54 project from the cover block 15b. The periphery of the through hole 42 provides a seat surface for receiving the screw 42. The through hole 45 provides a seat surface for receiving the screw 44.

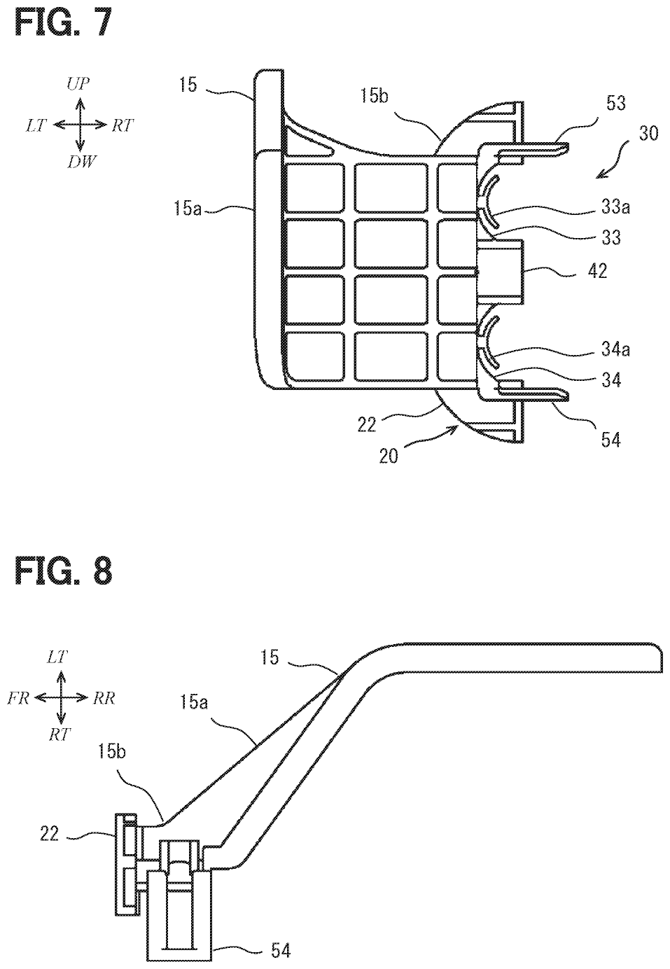

FIG. 7 shows the cover portion 15 and is a front view in a direction of an arrow VII in FIG. 6. The cover portion 15 has a plurality of half-circular cavities for the holder mechanism 30 on the divided surface of the cover block 15b. The cover block 15b has the cover depression portions 33 and 34 which provide the holder mechanism 30 on the surface forming the longitudinal axis. The base depression portions 33 and 34 are positioned behind the base end portion 22 and support the end pipes 12c and 12d as the holder mechanism 30. The cover depression portions 33 and 34 have contact pieces 33a and 34a. For example, one cover depression portion 33 has the contact piece 33a inside. The contact piece 33a contacts the outer surface of the end pipe 12c. The contact piece 33a can be elastically deformed by contacting the end pipe 12c. The contact piece 33a softly supports the end pipe 12c. The cover depression portion 34 also has a similar shape.

FIG. 8 shows the cover portion 15 and is a bottom view in a direction of an arrow VIII in FIG. 6. The hook 54 projects from the cover block 15b toward the base block 14b. In FIG. 4 to FIG. 8, the holder mechanism 30 spreads behind the base end portion 21 and the cover end portion 22 in parallel with the base end portion 21 and the cover end portion 22.

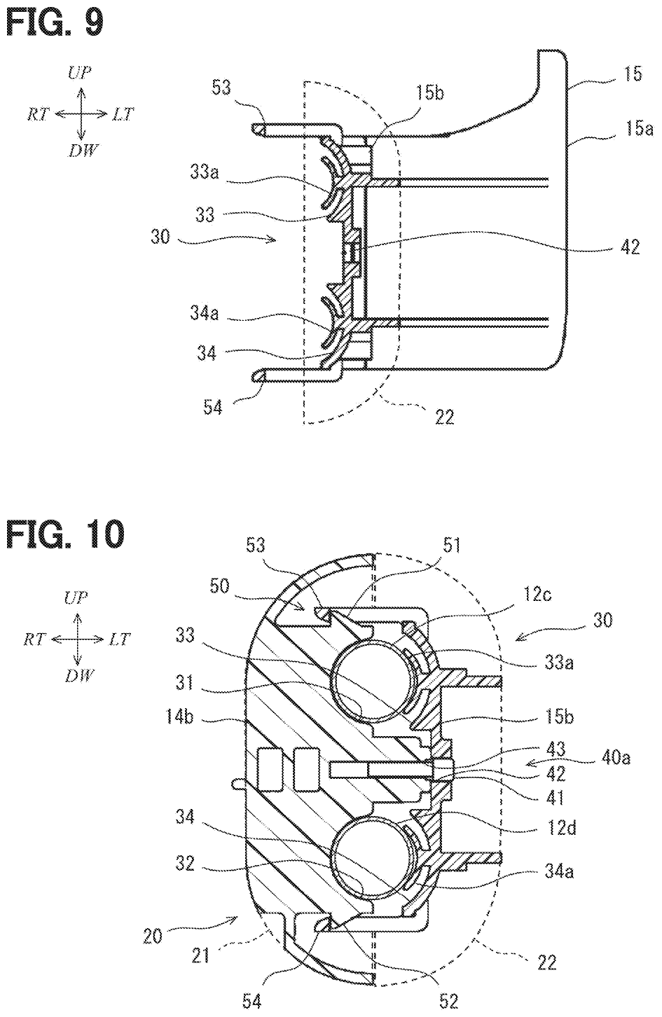

FIG. 9 shows a cross section of the cover portion 15, and is a cross sectional view taken along a line IX-IX of FIG. 6. The cover end portion 22 is illustrated by a dashed line.

FIG. 10 is an end view of the pipe support mechanism 13 including the base portion 14 and the cover portion 15. FIG. 10 shows an end face taken along the line IX-IX in FIG. 6 The cover end portion 22 is illustrated by a dashed line. Further, in FIG. 10, a cross section of the end pipes 12c and 12d is shown. The base block 14b and the cover block 15b are connected by the tightening mechanism 40a and the locking mechanism 50. The base block 14b and the cover block 15b provide the seat member 20 by connecting the base end portion 21 and the cover end portion 22. Further, the base block 14b and the cover block 15b provide the holder mechanism 30 for supporting the end pipes 12c and 12d by the base depression portions 31 and 32 and the cover depression portions 33 and 34. The base block 14b and the cover block 15b are connected by the tightening mechanism 40a and the connecting mechanism 40 including the locking mechanism 50.

The end pipes 12c and 12d are arranged along a boundary between the base end portion 21 and the cover end portion 22. In this example, the boundary is a dividing surface extending in the vertical direction. Each of the base depression portion and the cover depression portion has a plurality of base depression portions 31 and 32 and a plurality of cover depression portions 33 and 34 respectively. The plurality of base depression portions 31 and 32 support the plurality of end pipes 12c and 12d respectively. The plurality of cover depression portions 33 and 34 support the plurality of end pipes 12c and 12d respectively. Therefore, each of the base depression portion and the cover depression portion has a plurality of depressions which support the plurality of end pipes respectively.

In the method of manufacturing the air conditioner 10, first, a preparation process is executed. In the preparation process, the pipes 12a and 12b are bent into a prescribed shape. In the preparation step, the plurality of partial cases of the air conditioner 10 and the cover portion 15 are molded with a resin material. In the preparation step, a plurality of partial cases are assembled. Furthermore, in the preparation step, the heat exchanger 11 is arranged in the case 10e. Next, the pipes 12a and 12b are positioned at the prescribed positions of the air conditioner 10. At this time, the end pipes 12c and 12d are positioned in the base depression portions 31 and 32 of the base portion 14. Next, the cover part 15 is fixed. This fixing process includes three steps. The first step is to connect the cover portion 15 to the base portion 14 by the locking mechanism 50. The second step is performed after the first step to tighten the base portion 14 to the base portion by the tightening mechanism 40a. The third step is performed after the first step to tighten the cover portion 15 to the case by the tightening mechanism 40b. The order of the second step and the third step can be interchanged. According to this fixing step, the locking mechanism 50 provides a preliminary temporary fixing. Therefore, a positional deviation of the heat medium passage 12 due to subsequent second and third steps is suppressed. The seat member 20 is formed by the fixing process. Next, the seal member 16 is attached to the seat member 20. Next, the air conditioner 10 is mounted on the vehicle 1 so that the seal member 16 contacts the partition wall portion 4. In this way, the air conditioner 10 is completed.

According to this embodiment, the holder mechanism 30 supports the end pipes 12c and 12d immediately after the seat member 20. Therefore, the end pipes 12c and 12d can be reliably held with respect to the seat member 20 so as to suppress a positional deviation of the end pipes 12c and 12d. The holder mechanism 30 is connected by the tightening mechanism 40a and the locking mechanism 50. Therefore, the holder mechanism 30 can reliably support the end pipes 12c and 12d. The base end portion 21 and the cover end portion 22 which both provide the seat member 20. The base end portion 21 is integrally formed of a continuous resin material continuous to the base block 14b. The cover end portion 22 is integrally formed of a continuous resin material continuous to the cover block 15b. The base block 14b and the cover block 15b which both provide the holder mechanism 30. Therefore, the base end portion 21 and the cover end portion 22, which both provide the seat member 20, are integrally formed of a resin material on the base block 14b and on the cover block 15b respectively. Therefore, both the seat member 20 and the holder mechanism 30 may be formed by the base block 14b and the cover block 15b.

### Other Embodiments

The disclosure in this specification, the drawings, and the like is not limited to the illustrated embodiments. The disclosure encompasses the illustrated embodiments and variations thereof by those skilled in the art. For example, the present disclosure is not limited to the combinations of components and/or elements shown in the embodiments. The present disclosure may be implemented in various combinations. The present disclosure may have additional portions which may be added to the embodiments. The present disclosure encompasses omission of the components and/or elements of the embodiments. The present disclosure encompasses the replacement or combination of components and/or elements between one embodiment and another. The disclosed technical scope is not limited to the description of the embodiment. Several technical scopes disclosed are indicated by descriptions in the claims and should be understood to include all modifications within the meaning and scope equivalent to the descriptions in the claims.

In the above embodiment, a pipe for flowing the cooling liquid is used as the pipes 12a and 12b. Alternatively, each of the pipes 12a and 12b may be provided by a variety of pipe which passes through a fixed partition plate. For example, each of the pipes 12a and 12b may be a pipe for flowing the refrigerant of the vapor compression refrigeration cycle. For example, each of the pipes 12a and 12b may be a pipe for flowing a working medium such as an absorption solution of an absorption refrigeration cycle or water of an adsorption refrigeration cycle.

In the above embodiment, the base portion 14 is formed with the claws 51 and 52, and the cover portion 15 is formed with the hooks 53 and 54. Alternatively, hooks may be formed on the base portion 14 and claws may be formed on the cover portion 15. In addition, the locking mechanism 50 may be provided by various shapes of claws and hooks.

In the above embodiment, the two end pipes 12c and 12d are arranged in the vertical direction. Alternatively, the two end pipes 12c and 12d may be arranged side by side. It may be arranged in the left-right direction or in an oblique direction. In these cases, a connecting direction between the base block 14b and the cover block 15b is also the left-right direction or the oblique direction. Further, in the above-described embodiments, the seat portion 20 is provided by the base end portion 21 and the cover end portion 22. Alternatively, the seat member 20 may be provided by three or more members. In addition, the boundary between the plurality of members may be provided by various boundaries such as a straight line type, an L line type, a T line type, an N line type, and a W line type.

In the above embodiment, the base depression portions 31 and 32 and the cover depression portions 33 and 34 are arranged and tightened directly on the outer peripheries of the end pipes 12c and 12d. Alternatively, the base depression portions 31 and 32 and the cover depression portions 33 and 34 may be arranged and tightened, after arranging a cushion material around the outer peripheries of the end pipes 12c and 12d and arranging them. Further, in the above embodiment, the contact pieces 33a and 34a are provided in the cover depression portions 33 and 34, respectively. Alternatively, the contact pieces 33a and 34a may be provided on the base depression portions 31 and 32, or in both the base depression portions 31 and 32 and the cover depression portions 33 and 34.

What is claimed is:

1. An air conditioner with a pipe support, comprising:
a case accommodating a heat exchanger for exchanging heat between air and a heat medium;
at least one end pipe extends toward the heat exchanger from a partition wall portion which partitions a target room in which the case is arranged and a machine room and fluidly communicated with the heat exchanger;
a seat positioned to face the partition wall portion and to which the end pipe is positioned;
a seal mounted on the seat member and positioned between the facing portion and the partition wall portion; and
a holder which supports the end pipe, wherein
the seat and the holder are provided by a base portion formed of a resin material integrally with the case, a cover portion separately formed with the case, and a connecting mechanism which connects the base portion and the cover portion, and wherein
the base portion extends from the case toward the partition wall portion and has an base end portion providing a part of the seat and a base depression portion which is positioned behind the base end portion and supports the end pipe as the holder, and wherein
the cover portion is formed to be connected with the base portion and has a cover end portion providing a remaining part of the seat and a cover depression portion which is positioned behind the cover end portion and supports the end pipe as the holder, and wherein
the base portion includes:
a base stay extending from the case toward the partition wall portion; and
a base block arranged at a distal end of the base stay and having the base end portion and the base depression portion, and wherein
the cover portion includes: a cover stay connected to the case; and
a cover block arranged at a distal end of the cover stay and having the cover end portion and the cover depression portion.

2. The air conditioner with a pipe support claimed in claim 1, wherein
the connecting mechanism includes:
a tightening mechanism which tightens the base depression portion and the cover depression portion with a screw; and
a locking mechanism which connects the base portion and the cover portion by utilizing elastic deformation of a resin material.

3. The air conditioner with a pipe support claimed in claim 2, wherein
the plurality of end pipes includes two end pipes, and wherein
the tightening mechanism is positioned between the two end pipes, and wherein
the locking mechanism connects the base portion and the cover portion on both sides of the two end pipes.

4. The air conditioner with a pipe support claimed in claim 2, wherein
the tightening mechanism includes:
a screw;
a through hole provided in the cover portion; and
a female screw hole provided in the base depression portion or the case, and wherein
the locking mechanism is a snap fit mechanism including a claw and a hook.

5. The air conditioner with a pipe support claimed in claim 2, wherein
the connecting mechanism further includes a tightening mechanism which tightens the cover portion and the case with a screw.

6. The air conditioner with a pipe support claimed in claim 1, wherein
the base depression portion or the cover depression portion has a contact piece which comes into contact with the end pipe.

7. The air conditioner with a pipe support claimed in claim 1, wherein
the base end portion and the cover end portion spread in parallel with the partition wall portion, and wherein
the holder spreads behind the base end portion and the cover end portion in parallel with the base end portion and the cover end portion.

8. The air conditioner with a pipe support claimed in claim 1, wherein
the seat and the holder are arranged adjacent to each other along an extending direction of the end pipe.

9. The air conditioner with a pipe support claimed in claim 1, wherein
the pipe includes a plurality of end pipes arranged along a boundary between the base end portion and the cover end portion, and wherein
each of the base depression portion and the cover depression portion has a plurality of depressions which support the plurality of end pipes respectively.

10. An air conditioner with a pipe support, comprising:
a case accommodating a heat exchanger for exchanging heat between air and a heat medium;
at least one end pipe extends toward the heat exchanger from a partition wall portion which partitions a target room in which the case is arranged and a machine room and fluidly communicated with the heat exchanger;
a seat positioned to face the partition wall portion and to which the end pipe is positioned;
a seal mounted on the seat member and positioned between the facing portion and the partition wall portion; and
a holder which supports the end pipe, wherein
the seat and the holder are provided by a base portion formed of a resin material integrally with the case, a cover portion separately formed with the case, and a connecting mechanism which connects the base portion and the cover portion, and wherein
the base portion extends from the case toward the partition wall portion and has an base end portion providing a part of the seat and a base depression portion which is positioned behind the base end portion and supports the end pipe as the holder, and wherein
the cover portion is formed to be connected with the base portion and has a cover end portion providing a remaining part of the seat and a cover depression portion which is positioned behind the cover end portion and supports the end pipe as the holder, and wherein
the connecting mechanism includes:
a tightening mechanism which tightens the base depression portion and the cover depression portion with a screw; and
a locking mechanism which connects the base portion and the cover portion by utilizing elastic deformation of a resin material.

11. The air conditioner with a pipe support claimed in claim 10, wherein
the plurality of end pipes includes two end pipes, and wherein
the tightening mechanism is positioned between the two end pipes, and wherein
the locking mechanism connects the base portion and the cover portion on both sides of the two end pipes.

12. The air conditioner with a pipe support claimed in claim 10, wherein
the tightening mechanism includes:
a screw;
a through hole provided in the cover portion; and
a female screw hole provided in the base depression portion or the case, and wherein
the locking mechanism is a snap fit mechanism including a claw and a hook.

13. The air conditioner with a pipe support claimed in claim 10, wherein
the connecting mechanism further includes a tightening mechanism which tightens the cover portion and the case with a screw.

14. The air conditioner with a pipe support claimed in claim 10, wherein
the base depression portion or the cover depression portion has a contact piece which comes into contact with the end pipe.

15. The air conditioner with a pipe support claimed in claim 10, wherein
the base end portion and the cover end portion spread in parallel with the partition wall portion, and wherein
the holder spreads behind the base end portion and the cover end portion in parallel with the base end portion and the cover end portion.

16. The air conditioner with a pipe support claimed in claim 10, wherein
the seat and the holder are arranged adjacent to each other along an extending direction of the end pipe.

17. The air conditioner with a pipe support claimed in claim 10, wherein
the pipe includes a plurality of end pipes arranged along a boundary between the base end portion and the cover end portion, and wherein
each of the base depression portion and the cover depression portion has a plurality of depressions which support the plurality of end pipes respectively.
